(19) United States
(12) Patent Application Publication
(10) Pub. No.: US 2017/0352273 A1
(43) Pub. Date: Dec. 7, 2017

(54) POINT-TO-POINT PERSONAL COMMUNICATIONS IN THE CONTEXT OF VEHICLES

(71) Applicant: Nokia Technologies Oy, Espoo (FI)

(72) Inventors: Marko Tuukkanen, Schlenzer (DE); Jerome Beaurepaire, Berlin (DE)

(21) Appl. No.: 15/539,939

(22) PCT Filed: Dec. 29, 2014
(86) PCT No.: PCT/US14/72531

§ 371 Date: Jun. 26, 2017

(51) Int. Cl. G08G 1/16; G08G 1/0965; G07C 5/00

(52) U.S. Cl. CPC G08G 1/162; G07C 5/008; G08G 1/0965

(57) ABSTRACT

Methods and apparatus, including computer program products, are provided for point-to-point communications. In one aspect there is provided a method. The method may include detecting, at a first vehicle including a first user equipment, an occurrence of an event; changing, at the first vehicle including the first user equipment, a privacy setting to allow establishment of a local link and transmission of an indication representative of the event; transmitting, at the first vehicle including the first user equipment, the indication in response to the occurrence of the event, when allowed by the privacy setting; and establishing, at the first vehicle including the first user equipment, the local link to at least a second vehicle including a second user equipment, when allowed by the privacy setting. Related apparatus, systems, methods, and articles are also described.

### FIELD

The subject matter described herein relates to wireless communication.

### BACKGROUND

Vehicles may include radio systems in order to provide or obtain information, such as traffic information, weather information, and the like. This information may be provided to, or obtained from, other vehicles and/or sensors. For example, a vehicle may automatically obtain traffic information from roadside sensors, and this information may indicate a possible roadside hazard, such as road ice. The use of this information may facilitate autonomous, driverless vehicles as well as enhance the driver-based vehicle experience.

### SUMMARY

Methods and apparatus, including computer program products, are provided for point-to-point communications.

In some example embodiments, there is provided a method. The method may include detecting, at a first vehicle including a first user equipment, an occurrence of an event; changing, at the first vehicle including the first user equipment, a privacy setting to allow establishment of a local link and transmission of an indication representative of the event; transmitting, at the first vehicle including the first user equipment, the indication in response to the occurrence of the event, when allowed by the privacy setting; and establishing, at the first vehicle including the first user equipment, the local link to at least a second vehicle including a second user equipment, when allowed by the privacy setting.

In some variations, one or more of the features disclosed herein including the following features can optionally be included in any feasible combination. The method may further include defining the event including at least one rule mapped to the event, wherein the occurrence of the event triggers execution of the at least one rule. The at least one rule may include at least one of assessing a condition of the first vehicle and determining a severity of the event for the first vehicle. The indication may be defined based on at least a severity of the event. The indication may be transmitted via the local link. Vehicle-to-vehicle communications may be established over the established local link, when allowed by the privacy setting. Personal communications may be established over the established local link, when allowed by the privacy setting. The personal communication may include direct communications between the first user equipment and the second user equipment in the second vehicle. The event may include an accident. The first user equipment and the second user equipment may include at least one of a cell phone, a smart phone, or a tablet. The local link may include at least one of a Bluetooth link, a Bluetooth Low-Energy link, a near field communications link, a WiFi link, an optical laser link, or an infrared link.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF THE DRAWINGS

In the drawings,

FIGS. 1A-1B depict examples of systems for point-to-point communication among vehicles, in accordance with some example embodiments;

FIG. 2 depicts an example of a process for point-to-point communication among vehicles, in accordance with some example embodiments;

FIG. 3 depicts an example of a radio-based apparatus, in accordance with some example embodiments.

Like labels are used to refer to same or similar items in the drawings.

### DETAILED DESCRIPTION

Vehicles may include vehicle-based radio systems in order to provide vehicle-to-vehicle communications. For example, vehicles equipped with vehicle-to-vehicle radios may exchange traffic information, road conditions, alerts, warnings, autonomous vehicle-related information, and/or any other information. The vehicle-to-vehicle radios may establish point-to-point short-range links (for example, Bluetooth, Bluetooth Low-Energy, near field communications (NFC), WiFi, laser links, infrared links, and/or any other radio technology) directly between the vehicles, although the communications may be via other devices and/or networks as well including relays, access points, base stations, and/or the public land mobile network. Moreover, vehicle-to-vehicle radios may, in many instances, exchange information automatically over the vehicle-to-vehicle short-range links/communication infrastructure, without involving the vehicle's driver.

In some example, there may be provided personal communications, such as person-to-vehicle, vehicle-to-person communications, and/or person-to-person communications, via the vehicle-to-vehicle short-range links/communication infrastructure.

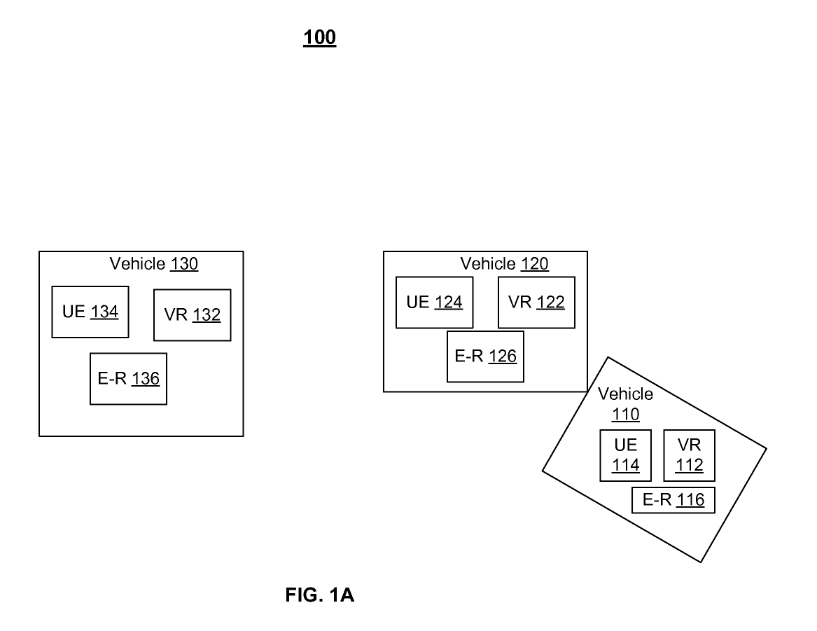

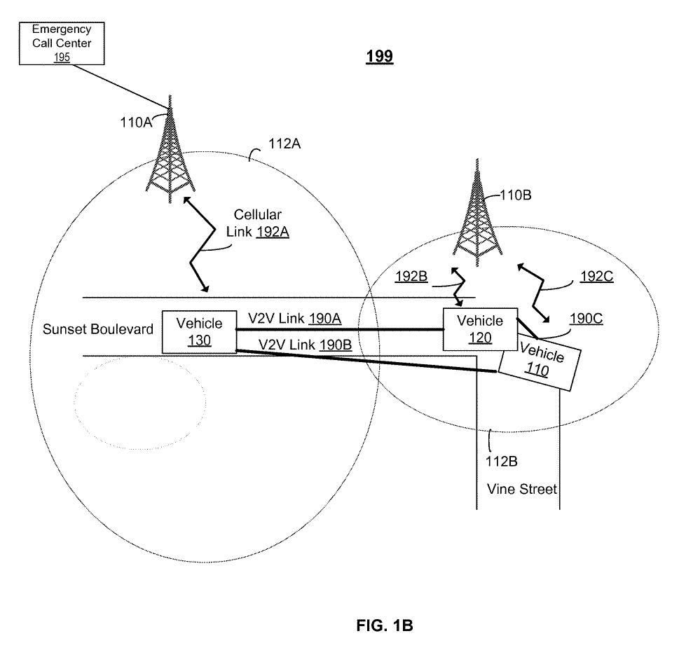

FIG. 1A depicts an example system 100 including a plurality of vehicles 110-130, in accordance with some example embodiments.

The vehicles 110-130 may comprise any type of vehicle, such as a car, a motorcycle, a bicycle, an aerial drone, and/or the like. Moreover, each vehicle may include a radio-based system to provide the vehicle-to-vehicle (V2V) communication infrastructure, which may include short-range links 190A-C (labeled V2V links). In the example of FIG. 1, vehicle 110 may include a vehicle radio 112 (labeled VR), which may communicate, as part of the vehicle-to-vehicle communications infrastructure, with other sensors, access points, networks, and/or vehicles, such as vehicle 120 including vehicle radio 122 and/or vehicle 130 including vehicle radio 132.

In some example embodiments, vehicle radios 112, 122, and 132 may establish point-to-point, short-range links (for example, Bluetooth, Bluetooth Low-Energy, near field communications (NFC), WiFi, laser links, infrared links, and/or any other radio technology) in order to exchange information, such as traffic conditions, weather, car location information, warnings (for example, that another vehicle is too close or poses a hazard), autonomous driving-related information, and/or any other information. Moreover, vehicle radios 112, 122, and 132 may communicate with other sensors, relays, access points, networks, and/or devices as well, including roadside sensors (for example, traffic lights), roadside relays that extend or repeat the transmissions of other vehicles, and/or the like. Vehicle radios 112, 122, and 132 may thus provide the vehicle-to-vehicle communications infrastructure described herein.

Although communications among vehicle radios 112, 122, and 132 may be via direct point-to-point, short-range links, the communications may also include, or be under the control of, another node or network, such as a wireless access point/base station and/or public land mobile network.

In some example embodiments, vehicles 110-130 may also include user equipment (labeled UE) 114, 124, and/or 134. The user equipment 112, 122, and/or 132 may provide the so-called “personal” communication in accordance with some example embodiments. The personal communications may include person-to-vehicle, vehicle-to-person communications, and/or person-to-person communications, and the personal communications may be carried via at least the vehicle-to-vehicle, short-range links. The user equipment may be coupled directly to, or be included in, the vehicle radio. Examples of the user equipment include a smart phone, a cell phone, a tablet, and/or any other type of radio capable of providing personal communications capability to the occupants (for example, the driver and/or passengers) of a vehicle. For example, vehicle radio 122 may scan for and discover at least user equipment 124 and then couple directly to user equipment 114. Alternatively or additionally, vehicle 120 including vehicle radio 122 may include a vehicle information system, such as a hands free communications apparatus, infotainment system, and/or the like, that interfaces and further includes user equipment 124 that provides, as part of the vehicle radio 122, the person-to-vehicle, vehicle-to-person communications, and/or person-to-person communications.

The vehicle-to-person or person-to-vehicle communications may correspond to a machine communicating with a person. For example, during an accident, an automated call may be made by a machine, such as a processor, to a person in another vehicle requesting or offering assistance. In the case of person-to-person, the call may be made from a first person to another person.

In some example embodiments, one or more events may be defined, such as a vehicle accident, emergency, roadside hazard, and/or any other type of event. In the example of FIG. 1, the defined events are stored in memory at for example event and rule registry (labeled E-R) 116, 126, and 136 at a corresponding vehicle. For example, when vehicles 110 and 120 collide, this may represent a predefined event stored at event and rule registry 116 and 126 at each of the vehicles. The vehicle radio may, based on the triggering event, process one or more rules. For example, a rule may be defined to trigger based on the accident and then assess the level/severity of the accident, which may include determining the condition of each vehicle 110 and 120 and/or the condition of vehicle occupants. To illustrate further, the collision of vehicles 110 and 120 may trigger an assessment that the collision is relatively major (for example, due to the deployment of airbags and/or data provided by another sensor).

When the collision is assessed to be relatively major for example, vehicle radios 112 and 122 may trigger one or more rules to perform one or more additional actions. For example, a triggered rule may cause at least one of the vehicle radios to make an emergency call, such as a 911 call and/or any other designated emergency number. Moreover, the triggered rule may define other actions related to when, where, and how emergency calls should be made by vehicle radios. For example, a rule may define that the emergency call may include one or more of the following: vehicle location information (for example, the location of vehicles 110 and 120), information regarding the collision (for example, type of accident, relative severity level, were airbags deployed, and/or the like), information identifying the vehicles (for example, license plate information), information identifying the drivers (for example, name, driver's license information, call back phone number, and/or the like), information about the condition of the drivers (for example, hurt, dead, alive, not hurt, critical, and/or the like), and/or any other information which may sent as part of the emergency call.

When the collision is assessed to be relatively major for example, the vehicle radios may trigger a rule to change the privacy settings of vehicles 110, 120, and/or 130, in accordance with some example embodiments. For example, vehicle 110 and/or 120 may change the privacy and security settings at vehicle radio 112 and 122 to allow vehicle-to-vehicle communication, vehicle-to-person communication, and/or person-to-vehicle communication. When this is the case, vehicle radio 112 and 122 may each transmit or broadcast a signal and/or message to advertise the presence of vehicle 110 and 120. This broadcast may also include information regarding the event, such as an accident and/or the severity/level of the accident. The broadcast may also advertise availability for vehicle-to-vehicle communication, vehicle-to-person communication, and/or person-to-vehicle communication connection establishment as well, in accordance with some example embodiments. For example, vehicle radio 112 and/or vehicle radio 122 may transmit/broadcast the advertisement, which may be detected by vehicle 130 including vehicle radio 132 as vehicle 130 arrives at the scene of accident. In this example, the privacy settings may be changed to allow vehicle 130 to couple to each vehicle 110 and 120 in the case of a major event/accident, but in the case of a minor event/accident, the privacy settings may be changed to only allow vehicle 110 and 120 to couple to each other (and not allow vehicle 130).

In response to the detection of the advertisement, vehicle 130 including vehicle radio 132 may be allowed, based on the privacy setting, to establish a vehicle-to-vehicle connection to vehicle radios 122 and/or 112, in accordance with some example embodiments. For example, vehicle 130 may establish one or more short-range links to vehicle 110 and/or vehicle 120, and vehicle 130 may also establish a person-to-person communication over the short-range link(s) to vehicle 110 including user equipment 114 and/or vehicle 120 including user equipment 124. This person-to-person communication may comprise a call, an SMS text, a video call, and/or the like carried at least in part by the short-range vehicle-to-vehicle links among the vehicles.

When the person-to-person connection between vehicle 130 and one or both of vehicles 110 and 120 is established, the vehicle occupants may communicate and exchange information regarding their condition after the accident. For example, the occupants (for example, drivers and/or passengers) of vehicles 110 and 120 may be able to confirm their condition. Specifically, the occupants of vehicle 110 and/or 120 may send an indication (via user equipment 114 and 124) that the occupants are okay and thus require no further assistance from vehicle 130's driver or that the occupants are not okay and do need assistance from vehicle 130's driver for example. To illustrate further, after establishing a connection to vehicles 110 and/or 120, vehicle 130 including user equipment 134 may receive an indication that there is no need to stop to render assistance and thus vehicle 130 may continue driving past the scene of accident between vehicles 110 and 120, without the occupant of vehicle 130 ever leaving the vehicle (which in itself may represent a safety hazard). Alternatively or additionally, the information exchanged may cause an occupant of vehicle 130 to indicate or agree on a plan of action with the occupants of vehicles 120/130 (for example, rescue one or more of the drivers/passengers from the accident).

In some example embodiments, system 100 may avoid the need for duplicate emergency calls for the same accident. For example, after establishing connections to vehicles 110 and/or 120, vehicle 130 may determine that an emergency call has not been made, in which case user equipment 134 may make an emergency call on behalf of vehicles 110/120. On the other hand, vehicle 130 may determine that an emergency call has been made and thus inhibit user equipment 134 from making an emergency call on behalf of vehicles 110/120 to report the action. Although the previous example describes vehicle 130 making the determination of whether the emergency call has been made, other vehicles (or associated vehicle radio-circuitry) may control whether an emergency call is made as well. Alternatively or additionally, vehicle 130 may provide supplemental information (for example, a car camera video or picture) to an emergency call center, in accordance with some example embodiments.

FIG. 1B depicts an example system 199 including a plurality of vehicles 110-130, in accordance with some example embodiments. System 199 is similar to system 100 in some respect but includes additional features in accordance with some example embodiments.

As noted above, the personal communications, such as person-to-vehicle, vehicle-to-person communications, and/or person-to-person communications, may be carried at least in part by point-to-point local links, which may also carry the vehicle-to-vehicle communications information.

Referring to FIG. 1B, vehicles 120 and 110 may be allowed, based on a privacy setting for example, to establish local vehicle-to-vehicle short-range links 190A-C to provide the vehicle-to-vehicle communications infrastructure. The local vehicle-to-vehicle links 190A-C may comprise Bluetooth, Bluetooth Low-Energy, near field communications (NFC), WiFi, laser links, infrared links, and/or any other radio technology. The local vehicle-to-vehicle links 190A-C may also carry the personal communications in addition to the vehicle-to-vehicle communications. For example, after an event, such as an emergency/crash of vehicles 110 and 120, the occupants of vehicles 110 and 120 may communicate via link 190A-C to provide for example information regarding their condition after the accident. To illustrate further, user equipment 114 and 124 may be used by the occupants (for example, drivers and/or passengers) of vehicles 110 and 120 to confirm their condition after an event, such as an emergency or accident. When this is the case, vehicle 130 including user equipment 134 may receive from user equipment 114 and 124 via at least vehicle-to-vehicle links 190A-B an indication that the occupants are not okay and require assistance from vehicle 130′s driver. In this way, the vehicle radios interface cellular communications provided by the user equipment to the short-range, vehicle-to-vehicle links 190A-B. Moreover, vehicle 130 may, on behalf of vehicles 110 and/or 120, make a call via base station 110A to an emergency call center 195.

In some example embodiments, when a vehicle seeks to establish personal communications via local links 190A-C for example, the user equipment within the vehicle (as depicted at FIG. 1A) may signal the vehicle radio to provide a voice call interface to allow the user equipment's call to be carried by the local link transmitted by the vehicle radio. Alternatively or additionally, the user equipment may include an application or other user interface to enable connection establishment of the call (for example, on the calling side and/or the called side) via local links 190A-C. Alternatively or additionally, a user interface at the user equipment may present a list of vehicles in the local vicinity to which a local link may be established and a voice call may be made or received as part person-to-vehicle, vehicle-to-person communications, and/or person-to-person communications as disclosed herein.

Although the previous example described using the local links in the context of an event, such as an emergency, the calls made between vehicles via local vehicle links 190A-C may be used in non-emergency situations as well.

In some example embodiments, vehicle-to-person communication, person-to-vehicle communication, and/or person-to-person communication may be established over the vehicle-to-vehicle communication infrastructure, such as local vehicle-to-vehicle links 190A-C. The use of vehicle-to-vehicle communication infrastructure may be enabled based on the fulfilment of for example a criterion. For example, a predefined event may trigger the vehicle-to-vehicle communication infrastructure to carry the above-noted personal communications. Moreover, the predefined event may, as noted, have one or more associated rules. For example, an event, such as a car accident, may have an associated rule defined, which when executed determines the vehicle's condition and/or changes a privacy setting within the vehicle to allow a broadcast and/or allow the establishment of a personal communication link via the vehicle-to-vehicle communication infrastructure. The broadcast may also advertise or otherwise indicate the type of event, such as an accident, and/or the severity of the event. Moreover, there may be different types of broadcast signals transmitted by a vehicle for different levels of emergency. For example, a severe accident may have a predefined broadcast or beacon of a first type, while a less severe accident may have another type of beacon. The information in the broadcast may include other information as well including vehicle communication capabilities, driver/passenger devices within the vehicle, and/or the like. Moreover, the type of information included in the broadcast may vary based on the type or severity of the emergency.

Based on the type or level of emergency and available communication capabilities, only the vehicles involved, or all vehicles may be granted the rights to establish direct personal communications between one or more vehicles (or the user equipment therein) associated with the event. Thus, the subject matter disclosed herein may allow person-to-person, vehicle-to-person, and/or person-to-vehicle communications over the vehicle-to-vehicle infrastructure, and this personal communication may be enabled, when an event is triggered granting permission for the establishment of the links and/or the communications.

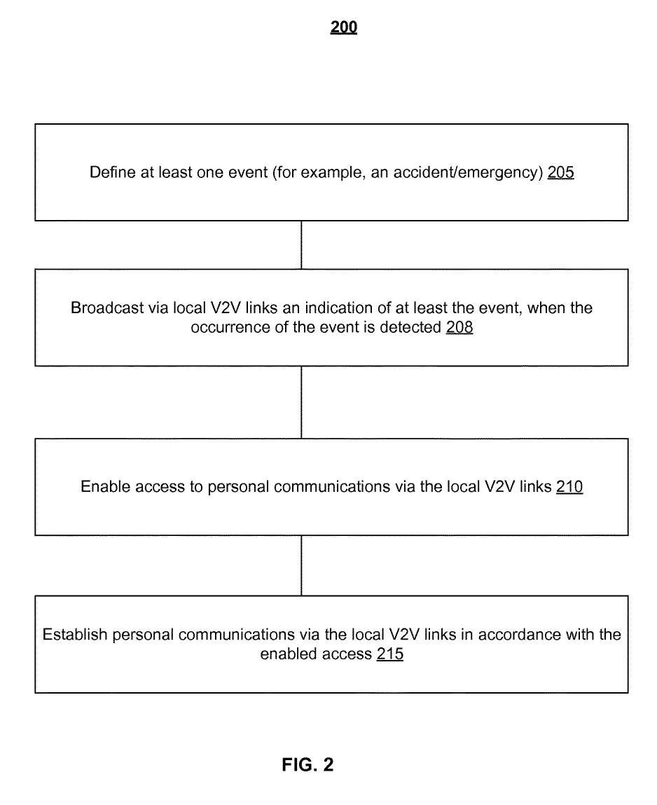

FIG. 2 depicts an example process for personal communications over vehicle-to-vehicle communications, in accordance with some example embodiments. The description of process 200 also refers to FIG. 1A-1B.

At 205, at least one event may be defined, in accordance with some example embodiments. Events, such as emergencies, traffic accidents, and/or the like, may be defined. The event definition may include what triggers the event. The events may also be mapped to one or more rules, such as conditions, actions, and/or the like to be performed, when the event is triggered. Moreover, event definitions may be provided by the network, such as a base station, defined via a user interface at a user equipment, defined by a standards, and/or defined in other ways as well. As noted above, an event may be defined as a major accident, which may be associated with one or more rules, such as assess the level/severity of the accident, determine the condition of each vehicle, determine the condition of vehicle occupants, scan for user equipment (for example, cell phones, wearable devices (which may include health information), and/or the like) in each vehicle, couple to discovered user equipment (if not coupled already), change the privacy settings of vehicles, transmit or broadcast a signal and/or message to advertise the presence of the vehicles in the accident, enable the establishment of local links to other vehicles, and/or enable personal communications to user equipment. The associated rules may also define the content of the broadcast (for example, the broadcast may signal the event type, severity, and/or other information).

At 208, an event indication may be broadcast via the local links, when a defined event is satisfied and thus triggered, in accordance with some example embodiments. When the event is triggered, the vehicle 110 and/or 120 may change a privacy and security settings in the vehicle radio 112 and 122 to allow vehicle-to-vehicle communication as well as personal communications (for example, person-to-person, communication vehicle-to-person communication and/or person-to-vehicle communication) and/or to allow a broadcast/transmission to advertise the presence of an event at vehicle 110 and 120. This broadcast may also include information regarding severity and/or event type, and may advertise availability for vehicle-to-vehicle communication, vehicle-to-person communication, and/or person-to-vehicle communication connection establishment as well, in accordance with some example embodiments.

At 210, access to personal communications may be allowed via established local vehicle-to-vehicle local links, in accordance with some example embodiments. The event may trigger a privacy setting change at a vehicle to allow vehicle-to-vehicle communications as well as personal communications. For example, the event may trigger vehicle 110 and 120 to allow, based on a privacy setting change, vehicle-to-vehicle and/or personal communications among the vehicles associated with the event, which may allow establishment of local link 190C. The event may also trigger vehicle 110 and 120 to allow, based on a privacy setting change, vehicle-to-vehicle and/or personal communications with other vehicles as well, such as vehicle 130. This change may be indicated explicitly in the broadcast sent at 208 or may be indicated based on the severity or type of event (in which case, the severity or type may trigger a rule at the vehicle to change its privacy setting).

For example, transmission at 208 may include information about the vehicles in the accident (for example, the presence of user equipment, severity of the accident, and/or the like). Based on the level or severity of the event and the availability of links, only vehicles 110 and 120 involved in the event/accident may be granted permission to establish local links and/or personal communications. Alternatively or additionally, vehicles 110 and 130 involved in the accident and at least one vehicle within range (for example, vehicle 130) may be granted permission to establish local links and/or personal communications. For example, in the case of a minor event or accident, local links and/or personal communications may be allowed only between the two vehicles 110 and 120 involved in the accident. When granted permission, vehicle 130 including vehicle radio 132 may establish short-range, vehicle-to-vehicle links 190A-B to vehicle radios 122 and/or 112, in response to the detection of the broadcast at 208. Moreover, the broadcast may indicate the availability of personal communications, such as user equipment 114 and 124 within the vehicles and whether the personal communications are allowed to be used via vehicle-to-vehicle links 190A-B.

At 215, personal communications may be established via the local vehicle-to-vehicle local links, in accordance with some example embodiments. For example, when the short-range, vehicle-to-vehicle links 190A-B are enabled for personal communications, vehicle 130 including user equipment 134 may establish a personal communications link via link 190A and vehicle radio 122 at vehicle 120, and vehicle 130/user equipment 130 may establish a personal communications link via link 190B and vehicle radio 112 at vehicle 110. In this way, personal communications may be established over the short-range, vehicle-to-vehicle links 190A-B.

In some example embodiments, different signals may be transmitted at 208 for different emergency levels. Moreover, these different signal types may be defined at 205, in accordance with some example embodiments.

Thus, in some example embodiments, a vehicle-to-vehicle communication infrastructure is configured to provide personal communications, such as person-to-vehicle, vehicle-to-person, and person-to person communications. This may enable a driver to send via a user equipment a warning to the vehicle (for example, a vehicle radio) and/or a person (for example, the user equipment), under certain conditions. Vehicle-to-vehicle communications may provide connected cars having connectivity via local point-to-point links/networks as well as other types of networks, such as cellular. Moreover, a vehicle may be able to discover and determine the presence of other wireless devices within the vehicle, which may indicate the identity of the occupants of the vehicle as well. For example, a user equipment within a vehicle may be detected, and this user equipment may be associated with a certain user. Furthermore, the user equipment may enable voice/phone connectivity, video call services, and the like. As such, when a vehicle performs the discovery of other wireless devices within the vehicle, the system may determine when a personal communication may be applied in a given vehicle (which may include providing a certain application or user interface to enable the personal communication, vehicle-to-person communication, person-to-vehicle communication, and/or person-to-person communication, via vehicle-to-vehicle communications infrastructure. In some example embodiments, a vehicle may inhibit personal communications from being activated (for example, to avoid being harassed by another driver or revealing information to others).

In some example embodiments, the vehicle-to-person communication may enable a vehicle to provide information to a person in another vehicle. In the case of an accident for example, the driver of a first vehicle may be unable to make a call or answer a phone. The vehicle may detect this driver state and then make and/or answer a call on behalf of the driver. A person in a second vehicle may be provided with a predetermined message generated by the first vehicle. If a voice recognition system is available, the communications may include questions, such as how badly are you hurt for example.

In some example embodiments, the personal communications may be joint, such as a conference call and/or a like among 2, 3, or more.

In some example embodiments, a first vehicle may allow another vehicle access to its communications capabilities. Referring to FIG. 1B, vehicle 110 may have cellular capabilities that are not operating due to for example the accident. When this is the case, vehicle 120 and/or 130 may provide the longer-range cellular communications access to vehicle 110, so vehicle 110 can couple to vehicle 120 and/or 130 and then vehicle 120 and/or 130 can complete the call via cellular on behalf of vehicle 110.

In some example embodiments, vehicles 110-130 may advertise available services and devices within each of the vehicles. For example, the available services may include a voice call, a video call, driver/passenger health monitoring, emergency calling, fuel monitoring, battery monitoring, and/or the like. In this example, a vehicle which has been in a collision may advertise these different services to other vehicles/users arriving at the scene of the accident. To illustrate further, this may allow a driver arriving at the scene to determine (for example, from a user interface) the health condition of the driver of a vehicle in the accident.

Although some of the examples refer to an event as an emergency such as an accident, any other event may be used to trigger the personal communications disclosed herein. For example, a driver's inability to operate a vehicle (for example, a sensor may detect a driver's medical condition, alcohol, and/or the like) may trigger the personal communications disclosed herein. When this is the case, an advertisement may broadcast the event to nearby drivers and allow drivers to communication with the driver with the medical condition and/or the like.

Referring again to FIG. 1B, base stations 110A and 110B may be configured as an evolved Node B (eNB) base station serving macrocells 112A and 112B (also referred to herein as cells and coverage areas). Moreover, when base stations 110A and 110B are implemented as an eNB type base station, as noted above, the base stations may be configured in accordance with standards, including the Long Term Evolution (LTE) standards, such as for example 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base stations 110A and 110B may also be configured to provide other types of air interfaces, such as various first generation (1G) communication protocols, second generation (2G or 2.5G) communication protocols, third-generation (3G) communication protocols, fourth-generation (4G) communication protocols, and/or any other wireless access network communication protocols. Although certain standards and technologies are described, these are merely examples as other standards and technologies may be used as well.

Although FIGS. 1A-1B depicts specific quantities of devices, other quantities may be used as well.

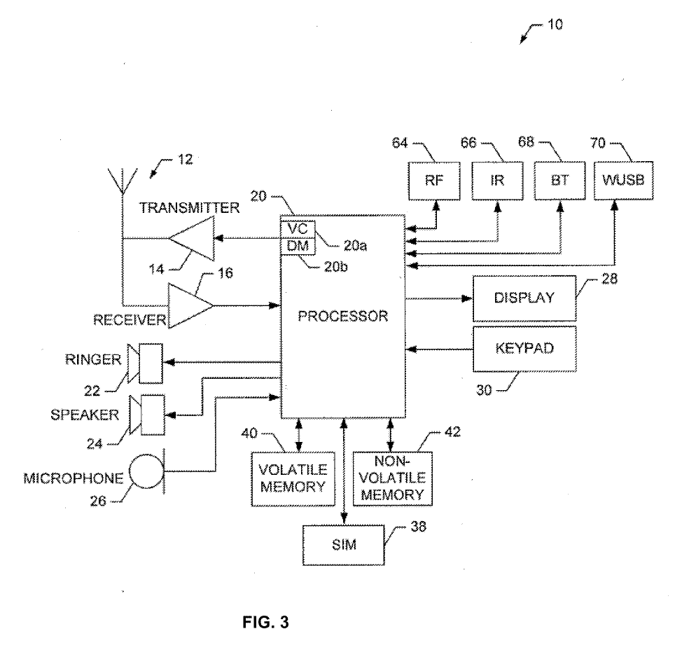

FIG. 3 illustrates a block diagram of an apparatus 10, which can be configured as user equipment, such as user equipment 114, 124, and 134, in accordance with some example embodiments. Moreover, the apparatus 10 may also be used to provide at least a portion of the base stations and/or the vehicle radios.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Apparatus 10 may include a location processor and/or an interface to obtain location information, such as positioning and/or navigation information. Accordingly, although illustrated in FIG. 3 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 3, apparatus 10 may also include one or more mechanisms for sharing and/or obtaining data. Moreover, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example within 10 meters. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as for example IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory, and/or the like. Like volatile memory 40, non-volatile memory 42 may include a cache area for temporary storage of data. At least part of the volatile and/or non-volatile memory may be embedded in processor 20. The memories may store one or more software programs (for example, an application and/or user interface associated with personal communications via local vehicle-to-vehicle links), instructions, pieces of information, data, and/or the like which may be used by the apparatus for performing functions of the user equipment/mobile terminal. The memories may comprise an identifier, such as for example an international mobile equipment identification (IMEI) code, capable of uniquely identifying apparatus 10. The functions may include one or more of the operations disclosed herein with respect to the user equipment, such as for example the functions disclosed at process 200. The memories may comprise an identifier, such as for example, an international mobile equipment identification (IMEI) code, capable of uniquely identifying apparatus 10. In the example embodiment, the processor 20 may be configured using computer code stored at memory 40 and/or 42 to provide process 200, and/or the like as disclosed herein.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example a computer or data processor circuitry, with examples depicted at FIG. 3. A computer-readable medium may comprise a non-transitory computer-readable storage medium that may be any media that can contain or store the instructions for use by or in connection with an instruction execution system, apparatus, or device, such as for example a computer. Furthermore, some of the embodiments disclosed herein include computer programs configured to cause methods as disclosed herein (see, for example, process 200 and/or the like).

Without in any way limiting the scope, interpretation, or application of the claims appearing below, a technical effect of one or more of the example embodiments disclosed herein is establishment of a direct communication channel between user involved in an event such as an accident, which may lead to shorter delays in communication between user involved in accident as well as user in passing vehicles.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

1-27. (canceled)

28. A method comprising:
detecting, at a first vehicle including a first user equipment, an occurrence of an event;
changing, at the first vehicle including the first user equipment, a privacy setting to allow establishment of a local link and transmission of an indication representative of the event;
transmitting, at the first vehicle including the first user equipment, the indication in response to the occurrence of the event, when allowed by the privacy setting; and
establishing, at the first vehicle including the first user equipment, the local link to at least a second vehicle including a second user equipment, when allowed by the privacy setting.

29. The method of claim 28 further comprising:
defining the event including at least one rule mapped to the event, wherein the occurrence of the event triggers execution of the at least one rule.

30. The method of claim 29, wherein the at least one rule includes at least one of assessing a condition of the first vehicle and determining a severity of the event for the first vehicle.

31. The method of claim 28 further comprising:
defining the indication based on at least a severity of the event.

32. The method of claim 28, wherein the indication is transmitted via the local link.

33. The method of claim 28 further comprising:
establishing vehicle-to-vehicle communications over the established local link, when allowed by the privacy setting.

34. The method of claim 28 further comprising:
establishing personal communications over the established local link, when allowed by the privacy setting.

35. The method of claim 34, wherein the personal communication comprises direct communications between the first user equipment and the second user equipment in the second vehicle.

36. The method of claim 28, wherein the event comprises a vehicle accident.

37. The method of claim 28, wherein the first user equipment and the second user equipment comprise at least one of a cell phone, a smart phone, a tablet, or a vehicle information system.

38. An apparatus comprising:
at least one processor; and
at least one memory including computer program code, the at least one memory and the computer program code configured to, with the at least one processor, cause the apparatus to perform at least the following:
detect, at a first vehicle including the apparatus, an occurrence of an event;
change, at the first vehicle including the apparatus, a privacy setting to allow establishment of a local link and transmission of an indication representative of the event;
transmit, at the first vehicle including the apparatus, the indication in response to the occurrence of the event, when allowed by the privacy setting; and
establish, at the first vehicle including the apparatus, the local link to at least a second vehicle including a second user equipment, when allowed by the privacy setting.

39. The apparatus of claim 38, wherein the apparatus is further configured to at least define the event including at least one rule mapped to the event, wherein the occurrence of the event triggers execution of the at least one rule.

40. The apparatus of claim 39, wherein the at least one rule includes at least one of assessing a condition of the first vehicle and determining a severity of the event first for vehicle.

41. The apparatus of claim 38, wherein the apparatus is further configured to at least define the indication based on at least a severity of the event.

42. The apparatus of claim 38, wherein the indication is transmitted via the local link.

43. The apparatus of claim 38, wherein the apparatus is further configured to at least establish vehicle-to-vehicle communications over the established local link, when allowed by the privacy setting.

44. The apparatus of claim 38, wherein the apparatus is further configured to at least establish personal communications over the established local link, when allowed by the privacy setting.

45. The apparatus of claim 44, wherein the personal communication comprises direct communications between the apparatus and the second user equipment in the second vehicle.

46. The apparatus of claim 38, wherein the event comprises an accident.

47. The apparatus of claim 38, wherein the apparatus comprises a first user equipment, wherein the first user equipment and the second user equipment comprise at least one of a cell phone, a smart phone, or a tablet.
